(19) United States
(12) Patent Application Publication
(10) Pub. No.: US 2017/0219726 A1
(43) Pub. Date: Aug. 3, 2017

(54) SYSTEMS AND METHODS FOR IMPROVED COUPLING OF GEOPHYSICAL SENSORS

(71) Applicant: CGG SERVICES SAS, Massy Cedex (FR)

(72) Inventors: Jason JUROK, East Grinstead (GB); Thomas BIANCHI, Paris (FR)

(73) Assignee: CGG SERVICES SAS, Massy Cedex (FR)

(21) Appl. No.: 15/327,106

(22) PCT Filed: Jul. 20, 2015
(86) PCT No.: PCT/IB2015/001538

§ 371 Date: Jan. 18, 2017

Related U.S. Application Data
(60) Provisional application No. 62/117,466, filed on Feb. 18, 2015.
(60) Provisional application No. 62/028,819, filed on Jul. 25, 2014.

(51) Int. Cl. G01V 1/16; G01V 1/18; E02D 3/12

(52) U.S. Cl. CPC G01V 1/168; E02D 3/12; G01V 1/181

(57) ABSTRACT

A system and method for coupling geophysical sensors is provided. A method for deploying a geophysical sensor includes treating an installation location with a soil stabilizing material. The method also includes pressing a die (906) into the installation location and after a predetermined time period, removing the die from the installation location. The method further includes installing a geophysical sensor in the installation location.

### CROSS-REFERENCE TO RELATED APPLICATION

This application claims the benefit under 35 U.S.C. §119(e) of U.S. Provisional Application Ser. No. 62/028,819 filed on Jul. 25, 2014 and U.S. Provisional Application Ser. No. 62/177,466 filed on Feb. 18, 2015, which are incorporated by reference in their entirety for all purposes.

### TECHNICAL FIELD

The present disclosure relates generally to seismic exploration tools and processes and, more particularly, to a system and method for coupling geophysical sensors.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected by subsurface seismic interfaces between underground formations having different acoustic impedances. Geophysical or seismic detectors, or “sensors,” located at or near the surface of the earth, in a body of water, or at known depths in boreholes, record the reflections and the resulting seismic data can be processed to yield information relating to the location and physical properties of the subsurface formations. Seismic data acquisition and processing generates a profile, or image, of the geophysical structure under the earth's surface. While this profile does not provide an accurate location for oil and gas reservoirs, it suggests, to those trained in the field, the presence or absence of them.

The seismic signal is emitted in the form of a wave that is reflected off interfaces between geological layers. When the wave encounters an interface between different media in the earth's subsurface a portion of the wave is reflected back to the earth's surface while the remainder of the wave is refracted through the interface. The reflected waves are received by an array of geophones, or geophysical sensors, located at the earth's surface, which convert the displacement of the ground resulting from the propagation of the waves into an electrical signal recorded by means of recording equipment.

Geophysical sensors are usually installed using a spike that penetrates the earth's surface to provide a mechanical coupling. In areas of unstable terrain, it is often difficult for a geophysical sensor be installed with a spike. Often this terrain is granular or inelastic, offering no shear frictional force with the spike, or the terrain is simply too hard to penetrate. In some cases the need for a mass deployment of geophysical sensors coupled with difficult terrain leaves little option to use a traditional ground spike. In addition, spikes can be considered a safety hazard, difficult to mechanize the deployment of, and tend to make dealing with large quantities of pre-connected line segments difficult. Moreover, seismic surveys often take place in geographic regions known for having highly variable soil conditions. For example, in arid desert areas, the soil is unconsolidated and thus provides very poor mechanical coupling between the geophysical sensor and the earth's surface. An extreme example of this condition would be pure sand.

The move towards extremely high channel count crews has left geophysical contractors with a need to find ways to mechanize, or automate, the deployment and installation of geophysical sensors. These large crews can no longer rely on manual human labor; either the number of people required are not available or it would be economically unfeasible to physically locate them on the crew. Another element to the large channel crew is the move towards single geophysical sensors in place of the typical multi-sensor array. As can be appreciated, the cost and complexity of laying out numerous geophysical sensors for each station has many drawbacks and using a single geophysical sensor is a logical choice. However, single sensors currently lack the sensitivity of a large array of geophysical sensors, and as such, it has become even more critical to ensure adequate mechanical coupling is addressed.

### SUMMARY

In accordance with some embodiments of the present disclosure, a method for deploying a geophysical sensor includes treating an installation location with a soil stabilizing material. The method also includes pressing a die into the installation location and after a predetermined time period, removing the die from the installation location. The method further includes installing a geophysical sensor in the installation location.

In accordance with anther embodiment of the present disclosure, a geophysical sensor assembly includes a geophysical sensor and a base magnetically coupled to a bottom surface of the geophysical sensor. The system also includes an interface coupled to the bottom surface of the base. The interface has a bottom surface that includes a coupling structure. The coupling structure is configured to provide mechanical coupling to a surface of a terrain.

In accordance with anther embodiment of the present disclosure, a method for deploying a geophysical sensor including determining a condition of a terrain at an installation location for a geophysical sensor. The method also includes, based on the condition of the terrain, selecting a geophysical sensor assembly including an interface having a bottom surface that includes a coupling structure. The coupling structure is configured to provide mechanical coupling to a surface of the terrain.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates an exemplary geophysical sensor assembly with a single layer of magnets in accordance with some embodiments of the present disclosure;

FIG. 2 illustrates an exemplary geophysical sensor assembly with two layers of magnets in accordance with some embodiments of the present disclosure;

FIG. 3 illustrates an exemplary geophysical sensor assembly with three layers of magnets in accordance with some embodiments of the present disclosure;

FIG. 4 illustrates an exemplary geophysical sensor assembly with two layers of magnets and a base/interface assembly in accordance with some embodiments of the present disclosure;

FIG. 5 illustrates an exemplary geophysical sensor assembly with a single layer of magnets configured in a base/interface assembly in accordance with some embodiments of the present disclosure;

FIG. 6 illustrates an exemplary ground plate assembly in accordance with some embodiments of the present disclosure;

FIG. 7 illustrates an exemplary geophysical sensor assembly including tapered interfaces in accordance with some embodiments of the present disclosure;

FIG. 8 illustrates an exemplary geophysical sensor assembly including a hemispherical interface in accordance with some embodiments of the present disclosure;

FIG. 9 illustrates an exemplary die assembly in accordance with some embodiments of the present disclosure;

FIG. 10 illustrates an exemplary die assembly including flanges in accordance with some embodiments of the present disclosure;

FIG. 11 illustrates a flow chart of an example method for installation of geophysical sensors for seismic exploration in accordance with some embodiments of the present disclosure; and

FIG. 12 illustrates an elevation view of an example seismic exploration system configured to produce images of the earth's subsurface geological structure in accordance with some embodiments of the present disclosure.

### DETAILED DESCRIPTION

The present disclosure is directed to systems and methods for improved mechanical coupling of geophysical sensors. As discussed previously, areas of unstable or unconsolidated terrain may make installation of geophysical sensors difficult. Further, insufficient mechanical coupling between the geophysical sensor and the earth's surface may decrease the effectiveness or accuracy of the data collected at the geophysical sensor. In some embodiments, installation of geophysical sensors is accomplished by the use of a base, also referred to as a “coupling plate,” “flat plate,” or “shoe,” that may be affixed to the geophysical sensor. The base may be configured or oriented for a particular geophysical sensor, or may be configured or oriented to couple to multiple sizes or types of geophysical sensors. The base may also be configured to attach to one or multiple interfaces that may include cleats or similar coupling structures. The particular interface utilized may be selected by an operator based on the terrain where the geophysical sensor is to be installed. In some surveys, the terrain across an exploration area may vary. As such, the operator may select different interfaces for installation of geophysical sensors in different locations based on terrain variations.

In some embodiments, the soil at the location for installation of the geophysical sensor may be treated. A die may be utilized in conjunction with the treated soil to generate a cavity for the geophysical sensor assembly. For example, a die may be installed in soil that has been treated and maintained in place for a predetermined time period, such as the time for the soil treatment material to dry or cure. The die may be integrated with or associated with a base plate to maintain the die in a specific orientation or depth during the predetermined time period. Thus, in some embodiments, the present disclosure assists in installation of geophysical sensors to improve mechanical coupling of the sensor with the earth's surface. Improved mechanical coupling may result in more accurate readings and data. Further, in some embodiments, the present disclosure provides installation methods for the geophysical sensors that may decrease risks to health and safety.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

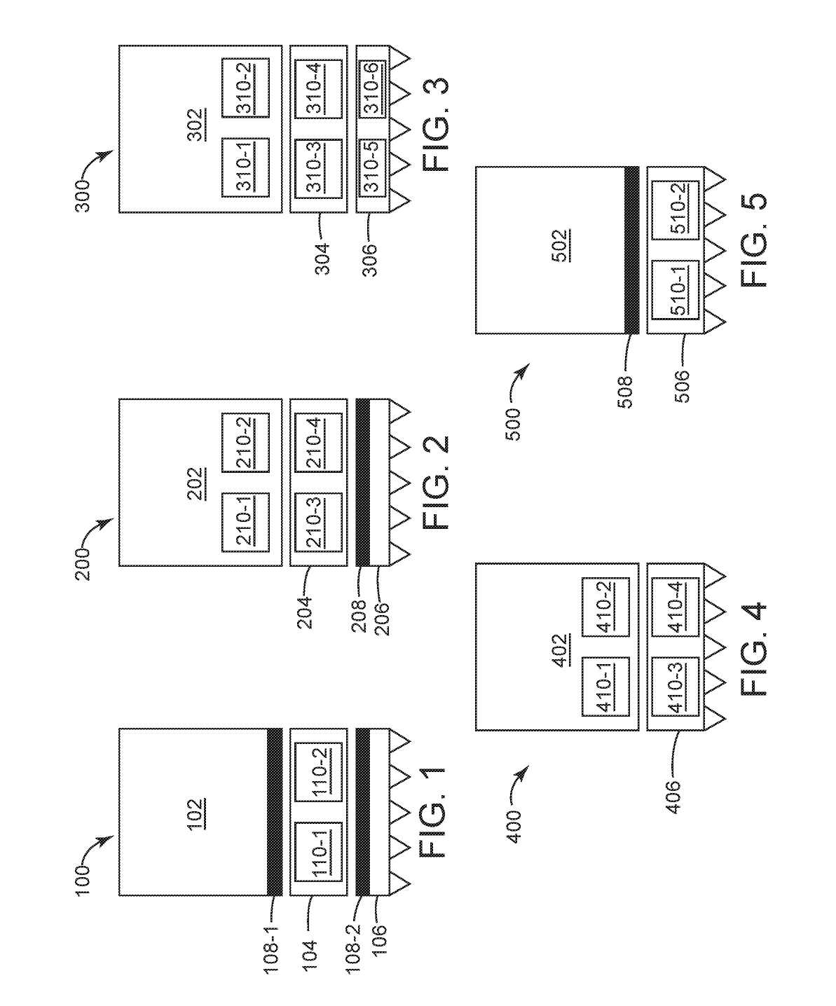

FIGS. 1 through 5 illustrate exemplary configurations of a geophysical sensor assembly. In some embodiments, a single layer of one or more magnets in cooperation with one or more ferromagnetic plates may be used to provide the magnetic coupling force between the sensor, the base, and the interface. In some embodiments, a single layer of magnets is configured in a base of the geophysical sensor assembly, for example, as shown in FIG. 1. In this case, both the sensor and the interface may include a ferromagnetic plate to provide sufficient clamping force or magnetic coupling. In some embodiments, the base and interface are integrated into a base/interface assembly. In this case, the single layer of magnets may be configured in the base/interface assembly (for example, as shown in FIG. 5) or may be configured in the sensor. The ferromagnetic plate may be located affixed to the sensor or the base/interface assembly, depending on the configuration. The use of a single layer of magnets in cooperation with one or more ferromagnetic plates may minimize costs and minimize the overall height of the geophysical sensor assembly, while maintaining the mechanical integrity of the interfaces between the components of the geophysical sensor assembly. Mechanical integrity may refer to the need to minimize or eliminate any movement of components of the geophysical sensor assembly relative to each other that allow the components to become loose, rattle, or otherwise individually move.

In some embodiments, the geophysical sensor assembly may include multiple layers of one or more magnets configured in the sensor, the base, or the interface to provide additional clamping force or magnetic coupling. For example, a geophysical sensor assembly may include a layer of magnets configured in the sensor and another layer of one or more magnets configured in the base or a base/interface assembly, as shown in FIGS. 2 and 4, respectively. Such a configuration may provide additional clamping force between the sensor and the base or the sensor and the base/interface assembly. As another example, a geophysical sensor assembly may include a layer of magnets in the sensor, a second layer of magnets in the base, and a third layer of magnets in the interface, as shown in FIG. 2. This configuration may provide additional clamping force between the components of the geophysical sensor assembly.

Moreover, in some embodiments, other coupling mechanisms may be utilized. For example, a base may be substantially affixed to a sensor via screws, fasteners, welds, adhesive, or any other suitable fastening mechanism. In some embodiments, such as using a base/interface assembly, the base in interface may be substantially affixed to the interface via screws, fasteners, welds, adhesive, or any other suitable fastening mechanism.

Turning to the figures, FIG. 1 illustrates an exemplary geophysical sensor assembly 100 with a single layer of magnets 110 in accordance with some embodiments of the present disclosure. Sensor assembly 100 includes sensor 102, base 104, and interface 106. Sensor assembly 100 includes plate 108-1 affixed to a bottom surface of sensor 102, and plate 108-2 affixed to a top surface of interface 106. Base 104 may house magnets 110-1 and 110-2 to magnetically couple to plates 108-1 and 108-2.

FIG. 2 illustrates an exemplary geophysical sensor assembly 200 with two layers of magnets 210 in accordance with some embodiments of the present disclosure. Sensor assembly 200 includes sensor 202, base 204, and interface 206. Sensor assembly 200 includes a first layer of magnets 210-1 and 210-2 configured in sensor 202 and a second layer of magnets 210-3 and 210-4 configured in base 204. Plate 208 is affixed to a top surface of interface 206. Magnets 210-1 and 210-2 magnetically couple with magnets 210-3 and 210-4. Further, magnets 210-3 and 210-4 magnetically couple with plate 208.

FIG. 3 illustrates an exemplary geophysical sensor assembly 300 with three layers of magnets 310 in accordance with some embodiments of the present disclosure. Sensor assembly 300 includes sensor 302, base 304, and interface 306. Sensor assembly 300 includes a first layer of magnets 310-1 and 310-2 configured in sensor 302, a second layer of magnets 310-3 and 310-4 configured in base 304, and a third layer of magnets 310-5 and 310-6. Magnets 310-1 and 310-2 magnetically couple with magnets 310-3 and 310-4. Further, magnets 310-3 and 310-4 magnetically couple with magnets 310-5 and 310-6.

FIG. 4 illustrates an exemplary geophysical sensor assembly 400 with two layers of magnets 410 and base/interface assembly 404 in accordance with some embodiments of the present disclosure. Sensor assembly 400 includes sensor 402 and base/interface assembly 406. Sensor assembly 400 includes a first layer of magnets 410-1 and 410-2 configured in sensor 402 and a second layer of magnets 410-3 and 410-4 configured in base/interface assembly 406. Magnets 410-1 and 410-2 magnetically couple with magnets 410-3 and 410-4.

FIG. 5 illustrates an exemplary geophysical sensor assembly 500 with a single layer of magnets 510 configured in base/interface assembly 504 in accordance with some embodiments of the present disclosure. Sensor assembly 500 includes sensor 502 and base/interface assembly 506. Sensor assembly 500 includes a single layer of magnets 510-1 and 510-2 configured in base/interface assembly 506. Plate 508 is affixed to a bottom surface of sensor 502. Magnets 510-1 and 510-2 magnetically couple with plate 508.

Plates 108, 208, and 508 may be affixed to the appropriate sensor or interface via screws, fasteners, adhesive, welding, or any other suitable attachment method. Plates 108, 208, and 508 may be constructed of any ferromagnetic material, such as metal, or any other suitable material that provides magnetic coupling to the appropriate magnets.

Bases 104, 204, and 304 may include a substantially flat top surface to couple with sensors 102, 202, and 302, respectively, and a substantially flat bottom surface to couple with interfaces 106, 206, and 306, respectively. In some embodiments, bases 104, 204, and 304 are constructed with a material of sufficient hardness or stiffness to minimize or eliminate any resonances at frequencies within the frequencies of the seismic band. For example, bases 104, 204, and 304 may be constructed of metal, aluminum, hard plastic, or other suitable material per the implementation.

Interfaces 106, 206, and 306 may include a substantially flat top surface to couple with bases 104, 204, and 304, respectively. The bottom surfaces of interfaces 106, 206, and 306 may include coupling structures, such as spikes, cleats, channels, ridges, or any other structure to enable sufficient mechanical coupling with the terrain of the earth's surface at the installation location of sensor assemblies 100, 200, and 300, respectively. Interfaces 106, 206, and 306 may be constructed of a material of sufficient hardness or stiffness to minimize or eliminate any resonances at frequencies within the frequencies of the seismic band, and a material that facilitates mechanical coupling to the terrain of the earth's surface at the installation location of sensor assemblies 100, 200, and 300, respectively.

Base/interface assemblies 406 and 506 may include a substantially flat top surface to couple with sensors 402 and 502, respectively. The bottom surfaces of base/interface assemblies 406 and 506 may include coupling structures, such as spikes, cleats, channels, ridges, or any other structure to enable sufficient mechanical coupling with the terrain of the surface at the installation location of sensor assemblies 400 and 500, respectively. Base/interface assemblies 406 and 506 may be constructed of a material of sufficient hardness or stiffness to minimize or eliminate any resonances at frequencies within the frequencies of the seismic band, and a material that facilitates mechanical coupling to the terrain of the earth's surface at the installation location of sensor assemblies 400 and 500, respectively.

The shapes and patterns of the bottom surfaces of interfaces 106, 206, and 306 and base/interface assemblies 406 and 506 may be designed for compatibility with mechanized deployment where the layout vehicle may be in constant motion. The use of ridges and various shapes and contours on the bottom surfaces of interfaces 106, 206, and 306 and base/interface assemblies 406 and 506 may further be selected based on compatibility with some terrain than others. Further, the bottom surfaces of interfaces 106, 206, and 306 and base/interface assemblies 406 and 506 may be designed such that individual coupling structures, such as spikes, cleats, ridges, or other structures are removable and replaceable as needed for the specific implementation.

Magnets 110, 210, 310, 410 and 510 may be construed of strong, rare earth magnets, other magnetic metals, ferrites, or alloys that exhibit ferromagnetic properties to provide the sufficient magnetic coupling force with the sensor, base, interface, or base/interface assembly as appropriate. Although each magnetic layer is illustrated as two similarly sized magnets, any suitable number and size of magnets may be utilized in any suitable orientation or location with respect to the structure in which they are configured. For example, with reference to FIG. 1, one larger magnet 110 may be utilized in place of magnets 110-1 and 110-2 to couple with plates 108-1 and 108-2.

The selection of a particular configuration of sensor assembly 100, 200, 300, 400, or 500 may be based on the necessary mechanical coupling force, the orientation of the assembly with respect to the terrain at the installation location, height limitations of the installation at a particular installation location, the need to interchange or exchange the interfaces for use at another location, characteristics of the terrain at the installation location, or any other suitable factor based on the specific implementation.

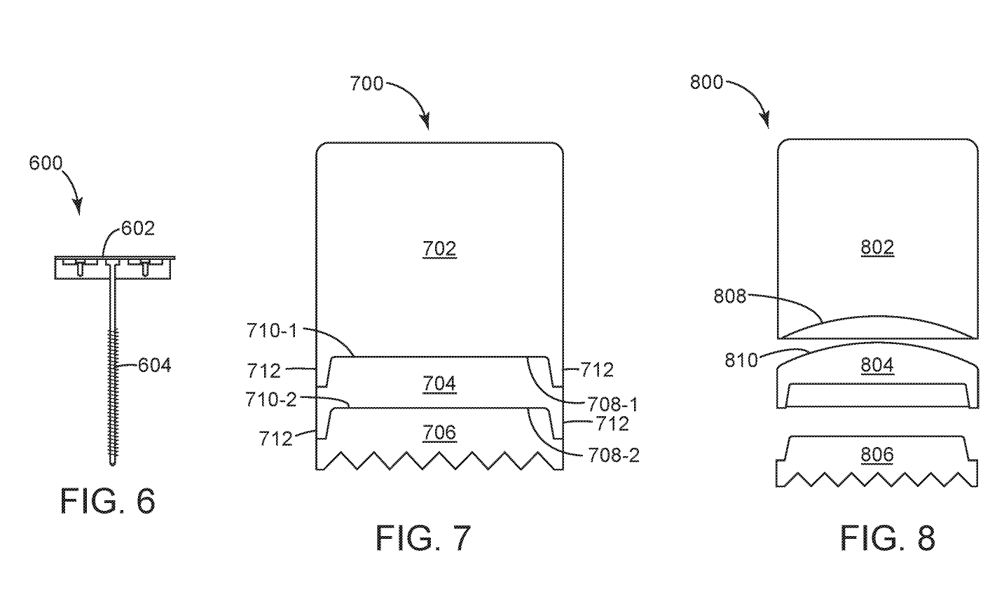

In some embodiments, the terrain of the installation location of a geophysical sensor assembly may include hard ground such that sufficient mechanical coupling may not be possible using the coupling structures, such as spikes, cleats, channels, ridges, or any other structure available with the exemplary interfaces. In this case, a ground plate with an additional fastener may be utilized to magnetically couple to the base or sensor. The additional fastener may include a long spike, a threaded screw, or other extended fastener. For example, FIG. 6 illustrates an exemplary ground plate assembly 600 in accordance with some embodiments of the present disclosure. Ground plate assembly 600 includes ground plate 602 and threaded screw 604. Ground plate assembly 600 may be configured to couple to base 104, 204, or 304, shown in FIGS. 1, 2, and 3 respectively, or sensor 202, 302 or 402, shown in FIGS. 2, 3, and 4, respectively. Ground plate 602 may be constructed of a material of sufficient hardness or stiffness to minimize or eliminate any resonances at frequencies within the frequencies of the seismic band. Ground plate 602 may include one or more holes to accommodate one or more threaded screws 604. Ground plate 602 may further include one or more magnets that provide magnetic coupling to a base or sensor, as appropriate. Threaded screw 604 may be constructed of metal or other suitable material of sufficient strength to penetrate the terrain at the installation location of the geophysical sensor assembly. Although ground plate assembly 600 is illustrated with one threaded screw 604, any number of threaded screws, spikes, or other extended fasteners may be utilized in some embodiments.

Further, although the interfaces between components of geophysical sensor assemblies 100, 200, 300, 400, and 500 are illustrated and described using substantially flat surfaces at the interfaces between components of the geophysical sensor assemblies, the surfaces at the interfaces may be of any shape or structure that may improve structural integrity of the interfaces. FIG. 7 illustrates an exemplary geophysical sensor assembly 700 including tapered interfaces in accordance with some embodiments of the present disclosure. Sensor assembly 700 may include sensor 702, base 704 and interface 706. Sensor 702 and base 704 may include inset tapered bottom surfaces 708-1 and 708-1. Base 704 and interface 706 may include extruded tapered top surface 710-1 and 710-2 configured to mate or correspond with inset tapered bottom surfaces 708-1 and 708-2, respectively. The interfaces between sensor 702 and base 704 may also include one or more flanges 712 to provide added mechanical stability.

FIG. 8 illustrates an exemplary geophysical sensor assembly 800 including a hemispherical interface in accordance with some embodiments of the present disclosure. Sensor assembly 800 may include sensor 802, base 804 and interface 806. Sensor 802 may include concave bottom surface 808. Base 804 may include convex top surface 810 configured to mate or correspond with concave bottom surface 808. Combinations of tapered interfaces, hemispherical interfaces, or other shaped interfaces generally, may be utilized in some embodiments.

Shaped interfaces to provide improved mechanical coupling at the interfaces between components of geophysical sensor assemblies may be used in addition to the magnetic coupling discussed with reference to FIG. 1 through 6. Using magnetic coupling and/or shaped interfaces per the present disclosure provides sufficient clamping force and provides a simplified method to modify geophysical sensor assemblies in the field. The present disclosure minimizes or eliminates the need for tools or special fixtures to accomplish modifications in the field. Further, the present disclosure maintains a low level of mechanical complexity based on the lack of moving parts. With respect to forces experienced by the geophysical sensor assembly, the use of magnetic coupling and/or shaped interfaces provides a single fastening point approximately in the center of the interfaces. A single fastening point reduces or eliminates any resultant asymmetrical forces that may result from an imbalance in forces related to having multiple fasteners.

Embodiments of the present disclosure may be suited for deployment in land surveys or ocean bottom surveys. In ocean bottom implementations, the geophysical sensor assembly may be encased in plastic or other substantially waterproof or water resistant material.

In some embodiments, seismic surveys may require placement of geophysical sensors in exploration areas that include unconsolidated soil. In such a case, treating the soil at the installation location for the geophysical sensor may improve the placement and mechanical coupling of the geophysical sensor. For example, the soil at the intended installation location may be treated chemically or physically. For chemical treatment, a soil treatment solution may be used that includes a soil stabilizer, such as, a vinyl acetate ethylene co-polymer, water, or other suitable environmentally safe soil stabilizer material. In some embodiments, a soil stabilizer may be used in cooperation with an emulsion where the total dissolved solids (TDS) inhibits easy absorption into the ground. In such a case, water may be used to pre-treat the area prior to creation of a cavity for the geophysical sensor, and then the soil stabilizer solution may be applied.

Further, the soil treatment and installation of the geophysical sensor may be somewhat mechanized thereby reducing expense and labor, and improving health and safety measures. As example, placement without soil treatment may necessitate an operator physically digging a cavity using a pickaxe, shovel, or similar tool, and physically pressing the geophysical sensor in the cavity. Disturbing the terrain in such a manner may result in poor near surface mechanical coupling of the geophysical sensor. In some embodiments, a method of using a soil stabilizer material includes saturating the unconsolidated soil in the area surrounding the installation location to soften the earth's surface and bring it to a state of plasticity. In this state, a die may be inserted that corresponds with the shape of the geophysical sensor to be installed. Using a soil stabilizer material in this manner reduces the amount of force needed to press the die into the soil. In some embodiments, the die may be slightly undersized to the shape of the geophysical sensor. During installation, the die may be pressed into the soil creating a cavity into which the geophysical sensor is subsequently placed. The die may remain in the soil for a pre-determined timer period to allow the soil stabilizer material to cure or dry, as appropriate. The use of the soil stabilizer acts to bind the unconsolidated soil such that when the die is removed the resultant cavity is stable and maintains its shape until the geophysical sensor is installed.

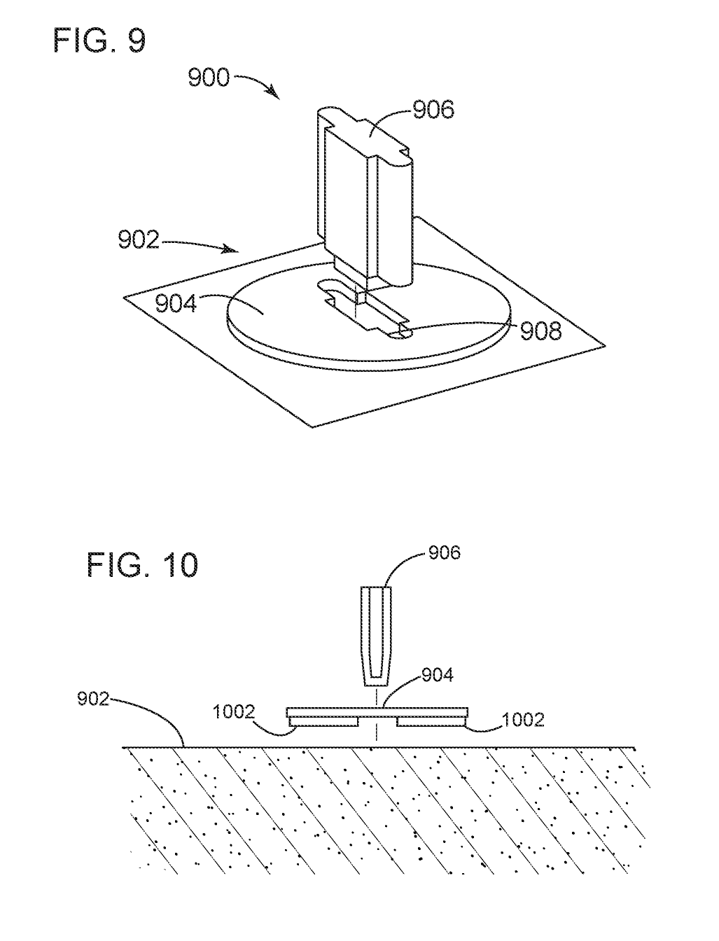

FIG. 9 illustrates an exemplary die assembly 900 in accordance with some embodiments of the present disclosure. Treated soil 902 may be soil that was previously unconsolidated soil but has been treated with a soil stabilizer material. Die assembly 900 operates in a portion of the exploration area with treated soil 902. Die assembly 900 may include baseplate 904 and die 906. Baseplate 904 may be of any suitable shape and includes cutout 908 that corresponds to the exterior shape of die 906. Use of baseplate 904 may assist in ensuring that the treated soil 902 is not substantially displaced vertically proximate to the cavity that is to be created by die 906, but is rather substantially symmetrically displaced in all directions. The compaction provided by baseplate 904 also may improve mechanical coupling of the geophysical sensor after installation. In some embodiments, die 906 may be slightly undersized compared to the size of the geophysical sensor to be installed, which may also improve mechanical coupling after installation. Baseplate 904 and die 906 may be constructed of metal, aluminum, or any suitable material of sufficient strength to create a cavity in treated soil 902.

During creation of the cavity, die 906 is pressed through cutout 908. Varying terrain conditions necessitates various amounts of force to press die 906 to create the cavity for the geophysical sensor. Thus, the amount of soil stabilizer may be varied based on soil conditions, and a layout vehicle with a ram may be utilized to provide the necessary force or weight on die 906 to create the cavity. Using a layout vehicle may also enable improved accuracy in placement based on antennas, global positioning system (GPS) equipment, cameras, or other computing devices available in a layout vehicle. In some embodiments, a linear actuator may be utilized in connection with baseplate 904 to compress the ground at the geophysical sensor installation location. Additionally, an auger or other digging device may be used in connection with die 906 and baseplate 904. A digging device may assist in leveling out the terrain proximate to the installation location for the geophysical sensor before or after using die 906 and baseplate 904. In some embodiments, based on the terrain, a soil stabilizer may be used on unconsolidated soil and the geophysical sensor may be placed without using die 906 or baseplate 904. The chemical treatment by the soil stabilizer material in cooperation with the weight of the geophysical sensor may be sufficient to provide adequate mechanical coupling between the geophysical sensor and the earth's surface.

In some embodiments, to facilitate the compression of the earth's surface, the ram located on the layout vehicle or the die assembly 900 may include a vibration generating mechanism. The vibrations from the vibration generating mechanism may assist the soil adjacent to the installation location to enter a reduced stress state, and thus allow less force to be used in creation of the cavity. The use of vibrations may also minimize soil sticking to die 906 or baseplate 904 during removal.

For some seismic surveys, placement of the geophysical sensor such that the top of the geophysical sensor is approximately flush with the earth's surface may be recommended, for example to avoid wind noise. Accordingly, in some embodiments, die 906 and baseplate 904 may be integrated into a single device to assist in ensuring that the depth of the resulting cavity is appropriate for the geophysical sensor. Additionally, in some embodiments, baseplate 904 may include chemical dispensing nozzles for dispensing the soil stabilizer material.

In some embodiments, flanges may be incorporated into the baseplate to provide channels in the treated soil to accommodate cables or other devices associated with the geophysical sensor. FIG. 10 illustrates an exemplary die assembly 1000 including flanges 1002 in accordance with some embodiments of the present disclosure. Baseplate 908 may include flanges 1002. Flanges 1002 may be configured and sized to create channels in treated soil 902 to accommodate cables and other devices necessary for operation of the geophysical sensor to be installed.

After the predetermined time period to allow the treated soil to cure or dry proximate to die 906, die 906 and baseplate 904 may be removed and the geophysical sensor is installed. Installation of the geophysical sensor may include covering the geophysical sensor covered with soil, a sand bag, or other material or structure, to reduce or substantially prevent wind noise and improve mechanical coupling with the earth's surface. Soil may be gather from nearby terrain or from the creation of nearby cavities for placement of other geophysical sensors. Further, any soil covering the geophysical sensor may also be treated with a soil stabilizer material to minimize the risk of the covering soil from being blown away.

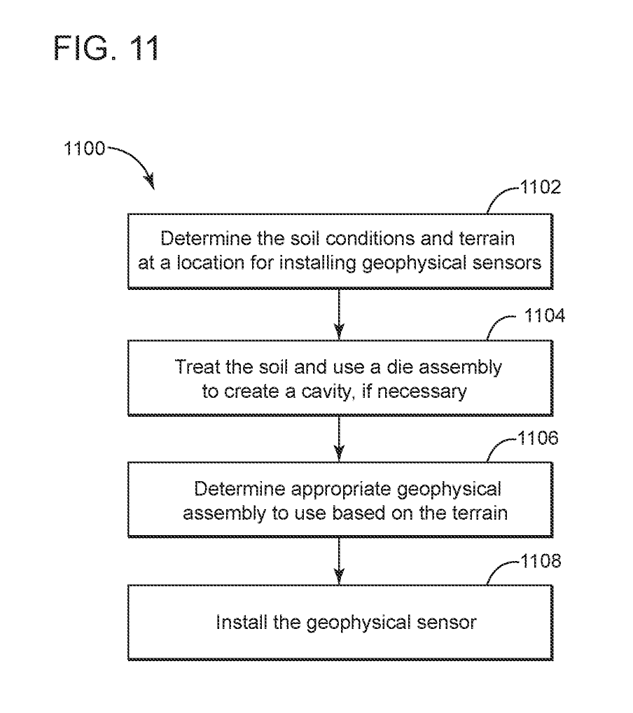

FIG. 11 illustrates a flow chart of example method 1100 for installing geophysical sensors for seismic exploration in accordance with some embodiments of the present disclosure. The method 1100 begins at step 1102, where an operator determines the soil conditions and terrain at a location for installation of a geophysical sensor in an exploration area for a seismic survey.

At step 1104, the operator treats the soil and creates cavities with a die assembly, if necessary. For example, if the soil is unconsolidated, the soil may be treated with a soil stabilizer material. A die assembly may be utilized to create a cavity for the installation of the geophysical sensor as discussed with reference to FIGS. 7 and 8.

At step 1106, the operator determines, based on the terrain, the appropriate geophysical sensor assembly to utilize. For example, any of the configurations of FIGS. 1 through 6 may be utilized based on the need for improved mechanical coupling between the geophysical sensor and the earth's surface. As example, the configuration of FIG. 6 may be utilized in cooperation with the geophysical sensor to provide improved mechanical coupling between the geophysical sensor and the earth's surface. At step 1108, the operator installs the geophysical sensor.

Modifications, additions, or omissions may be made to method 1100 without departing from the scope of the present disclosure. For example, the order of the steps may be performed in a different manner than that described and some steps may be performed at the same time. For example, step 1106 may be performed before step 1102. Additionally, each individual step may include additional steps without departing from the scope of the present disclosure. Further, more steps may be added or steps may be removed without departing from the scope of the disclosure.

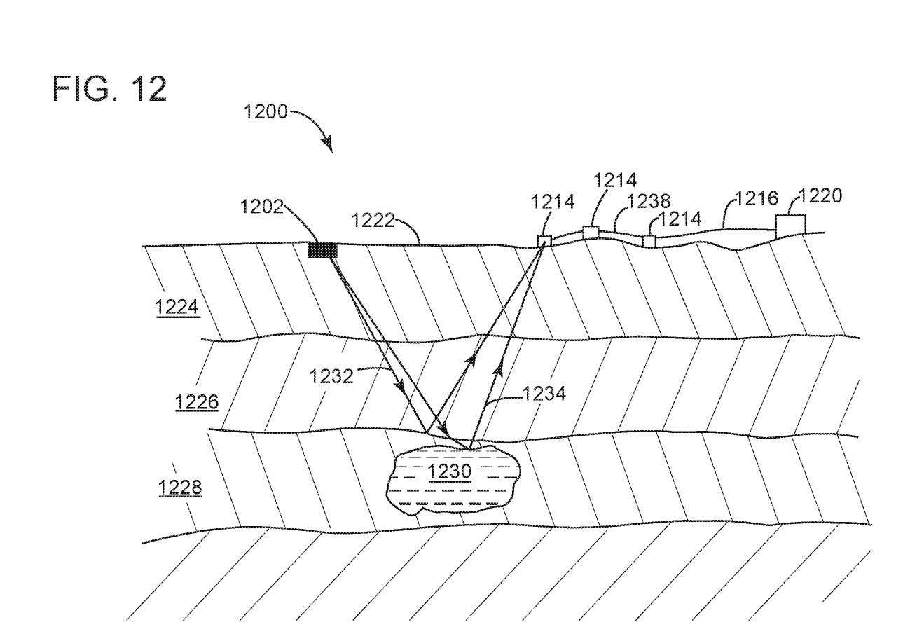

FIG. 12 illustrates an elevation view of an example seismic exploration system 1200 configured to produce images of the earth's subsurface geological structure in accordance with some embodiments of the present disclosure. System 1200 may use or employ any of the systems or methods for placement of geophysical sensors to improve mechanical coupling with the earth's surface discussed with reference to FIG. 1 through 10. The images produced by system 1200 allow for the evaluation of subsurface geology. System 1200 may include one or more seismic energy sources 1202 and one or more geophysical sensors 1214 which are located within a pre-determined exploration area. The exploration area may be any defined area selected for seismic survey or exploration. Survey of the exploration area may include the activation of seismic source 1202 that radiates an acoustic wave field that expands downwardly through the layers beneath the earth's surface. The seismic wave field is then partially reflected from the respective layers and recorded by geophysical sensors 1214. For example, source 1202 generates seismic waves and geophysical sensors 1214 record rays 1232 and 1234 reflected by interfaces between subsurface layers 1224, 1226, and 1228, oil and gas reservoirs, such as target reservoir 1230, or other subsurface structures.

Seismic energy source 1202 may be referred to as an acoustic source, seismic source, energy source, and source 1202. In some embodiments, source 1202 is located on or proximate to surface 1222 of the earth within an exploration area. Source 1202 may be operated by a central controller that coordinates the operation of several sources 1202. Further, a positioning system, such as a global positioning system (GPS), may be utilized to locate and time-correlate sources 1202 and geophysical sensors 1214. Source 1202 may comprise any type of seismic device that generates controlled seismic energy, such as a seismic vibrator, vibroseis, dynamite, an air gun, a thumper truck, or any other suitable seismic energy source.

Geophysical sensors 1214 may be located on or proximate to surface 1222 of the earth within an exploration area. Geophysical sensor 1214 may be any type of instrument that is operable to transform seismic energy or vibrations into a voltage signal. For example, geophysical sensor 1214 may be a vertical, horizontal, or multicomponent geophone, accelerometers, or optical fiber with wire or wireless data transmission, such as a three component (3C) geophone, a 3C accelerometer, or a 3C Digital Sensor Unit (DSU). Multiple geophysical sensors 1214 may be utilized within an exploration area to provide data related to multiple locations and distances from sources 1202. Geophysical sensors 1214 may be positioned in multiple configurations, such as linear, grid, array, or any other suitable configuration. In some embodiments, geophysical sensors 1214 may be positioned along one or more strings 1238. Each geophysical sensor 1214 is typically spaced apart from adjacent geophysical sensors 1214 in the string 1238. Spacing between geophysical sensors 1214 in string 1238 may be approximately the same preselected distance, or span, or the spacing may vary depending on a particular application, exploration area topology, or any other suitable parameter. For example, geophysical sensor or geophysical sensor assembly, from FIGS. 1 through 8, may be geophysical sensor 1214.

One or more geophysical sensors 1214 transmit raw seismic data from reflected seismic energy via network 1216 to computing unit 1230. Computing unit 1220 may perform seismic data processing on the raw seismic data to prepare the data for interpretation, and may also be configured to control geophysical sensors 1214. Computing unit 1220 may include any instrumentality or aggregation of instrumentalities operable to compute, classify, process, transmit, receive, store, display, record, or utilize any form of information, intelligence, or data. For example, computing unit 1220 may include one or more personal computers, storage devices, servers, or any other suitable device and may vary in size, shape, performance, functionality, and price.

Network 1216 may be configured to communicatively couple one or more components of system 1200. For example, network 1216 may communicatively couple geophysical sensors 1214 with computing unit 1220. Further, network 1214 may communicatively couple a particular geophysical sensor 1214 with other geophysical sensors 1214. Network 1214 may be any type of network that provides communication, such as one or more of a wireless network, a local area network (LAN), or a wide area network (WAN), such as the Internet.

Although discussed with reference to a land implementation, embodiments of the present disclosure are also useful in sea bed applications. In a seabed acquisition application, where geophysical sensor 1214 is placed on the seabed, monitoring device 1212 may include 3C geophone and hydrophones.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a geophysical sensor does not have to be turned on but must be configured to receive reflected energy.

Embodiments of the disclosure may also relate to an apparatus for performing the operations herein. This apparatus may be specially constructed for the required purposes. Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the disclosure is defined by the appended claims.

What is claimed is:

1. A method for deploying a geophysical sensor, comprising:
treating an installation location with a soil stabilizing material;
pressing a die into the installation location;
after a predetermined time period, removing the die from the installation location; and
installing a geophysical sensor in the installation location.

2. The method of claim 1, further comprising placing a baseplate at the installation location.

3. The method of claim 2, wherein pressing the die into the installation location includes inserting the die through a cutout in the baseplate.

4. The method of claim 2, wherein the baseplate and the die are integrated.

5. The method of claim 2, wherein pressing the die into the installation location includes determining a depth for the die that allows the geophysical sensor to be configured approximately flush with a surface after installation.

6. The method of claim 1, wherein the die is undersized with reference to the geophysical sensor.

7. The method of claim 1, wherein pressing the die into the installation location includes using a ram associated with a vehicle.

8. A geophysical sensor assembly comprising:
a geophysical sensor;
a base magnetically coupled to a bottom surface of the geophysical sensor; and
an interface coupled to the bottom surface of the base, the interface having a bottom surface that includes a coupling structure, the coupling structure configured to provide mechanical coupling to a surface of a terrain.

9. The assembly of claim 8, further comprising:
a first magnet configured in the base;
a first plate coupled to a bottom surface of the sensor; and
a second plated coupled to a top surface of the interface.

10. The assembly of claim 8, further comprising:
a first magnet configured in the base;
a second magnet configured in the sensor; and
a second plated coupled to a top surface of the interface.

11. The assembly of claim 8, further comprising:
a first magnet configured in the base;
a second magnet configured in the sensor; and
a third magnet configured in the interface.

12. The assembly of claim 8, further comprising:
a first magnet configured in the base, wherein the base is integrated with the interface; and
a second magnet configured in the sensor.

13. The assembly of claim 8, further comprising:
a first magnet configured in the base, the base is integrated with the interface; and
a first plate coupled to a bottom surface of the sensor.

14. The assembly of claim 8, wherein the coupling structure includes a plurality of cleats.

15. The assembly of claim 15, wherein the plurality of cleats are configured to be removed from the interface.

16. The assembly of claim 8, wherein the coupling structure includes an extended threaded screw.

17. A method for deploying a geophysical sensor, comprising:
determining a condition of a terrain at an installation location for a geophysical sensor; and
based on the condition of the terrain, selecting a geophysical sensor assembly including an interface having a bottom surface that includes a coupling structure, the coupling structure configured to provide mechanical coupling to a surface of the terrain.

18. The method of claim 17, wherein the geophysical sensor assembly includes a base magnetically coupled to the geophysical sensor and magnetically coupled to the interface.

19. The method of claim 17, wherein the interface is integrated with a base.

20. The method of claim 17, wherein the coupling structure includes a plurality of cleats.
